(19) United States
(12) Patent Application Publication
(10) Pub. No.: US 2022/0076245 A1
(43) Pub. Date: Mar. 10, 2022

(54) METHOD AND SYSTEM FOR A MULTI-MEMBER CRYPTOGRAPHIC WALLET

(71) Applicant: WORLDWEB GROUP PTY LIMITED, Adelaide (AU)

(72) Inventors: Christopher Weddle, Adelaide (AU); Aaron Kison, Adelaide (AU)

(21) Appl. No.: 17/418,029

(22) PCT Filed: Dec. 19, 2019
(86) PCT No.: PCT/AU2019/051400

§ 371 Date: Jun. 24, 2021

(30) Foreign Application Priority Data
Dec. 24, 2018 (AU) 2018904946

(51) Int. Cl. G06Q 20/36; H04L 9/08

(52) U.S. Cl. CPC G06Q 20/367; H04L 9/088

(57) ABSTRACT

A computer implemented method for adaptive key segmentation of a cryptographic key between participants for use in a multi-member cryptographic wallet is described. The method comprises determining a derivative key based on the cryptographic key, generating a plurality of bitmasks for splitting the derivative key, and generating m segments based on using the plurality of bitmasks. Each segment is associated with a corresponding participant and distributed thereto.

### FIELD

The present invention relates to a computer implemented method, software and system for cryptographic applications. In particular, the present invention relates to multi-member cryptographic wallets.

### BACKGROUND

Current cryptocurrency practice involves the use of digital wallets. A digital wallet is a software program that stores private and public keys and typically interfaces with a blockchain (or ledger) to enable users to perform transactions, for example to send and receive cryptocurrency.

A more complex type of wallet is a multi-signature wallet. In the art, this is a digital wallet associated with more than one private key. That is, more than one key is required to perform a transaction on the blockchain. One example is two-factor authentication. In this example, the wallet is associated with 2 private keys, and interacting with the wallet requires both keys.

There are significant security benefits of utilising a multi-signature wallet. For example use of a multi-signature wallet increases the difficulty of theft of the cryptocurrency associated with the wallet because a single private key, which may have been acquired nefariously, would be insufficient to perform a transaction. There are other benefits including sharing wallets and escrow. However, the use of multi-signatures can be problematic because multiple keys can mean key management and distribution can become complex. Therefore it is not easy or straightforward to add or remove participants, or to otherwise change the signature configuration of the wallet.

As a result, there is a need for a more flexible alternative to multi-signature wallets. One technical problem to be addressed is to maintain key security but at the same time improve flexibility in the use of the digital wallets.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY

Described herein is a computer implemented method for adaptive key segmentation of a cryptographic key between participants for use in a multi-member cryptographic wallet, the method comprising: determining a derivative key based on the cryptographic key; generating a plurality of bitmasks for splitting the derivative key, wherein a bitmask indicates for each bit in the derivative key whether the bit is required by a participant; generating m segments based on using the plurality of bitmasks on the derivative key wherein m is the number of participants; associating each segment with a corresponding participant; and distributing each segment to the corresponding participant, wherein, in use, the cryptographic key can be reconstructed from n segments to sign a transaction and wherein n is a minimum number of participant segments required based on a signature configuration for the multi-member cryptographic wallet.

Generating a plurality of bitmasks may comprise determining a solution table for the cryptographic key based on the signature configuration for the multi-member cryptographic wallet.

The method may further comprise converting the solution table into the plurality of bitmasks.

In some embodiments, the derivative key is the cryptographic key.

Determining a solution table may comprise: determining a first solution for one participant's segment based on signature requirements of the signature configuration; and determining a second solution for the remaining (n−1) participants' segment based on the remaining signature requirements of the signature configuration.

Determining the second solution may comprise recursively applying the steps of the above method.

The number of participants may be variable.

The method may further comprise: receiving n segments from the participants; reconstructing the cryptographic key from the received segments; determining a new derivative key based on the reconstructed cryptographic key; generating one or more new bitmasks for splitting the new derivative key, wherein a bitmask indicates for each bit in the new derivative key whether the bit is required by a participant; generating x new segments based on using the one or more new bitmasks on the new derivative key, wherein x is the new number of participants; associating each new segment with a corresponding participant; and distributing each new segment to the corresponding participant, wherein, in use, the cryptographic key can be reconstructed from y new segments to sign a transaction and wherein y is a minimum number of participant new segments required based on a signature configuration for the multi-member cryptographic wallet.

The method may further comprise: receiving a public key from each corresponding participant; and prior to distribution, encrypting each segment with the corresponding public key for each corresponding participant.

The method may be performed by a mediator system.

The method may further comprise reconstructing, by the mediator system, the cryptographic key from the segments.

Reconstructing the cryptographic key may comprise n participants sending their associated segment to the mediator system.

Also described herein is a non-transitory computer readable medium having computer readable instructions for adaptive key segmentation of a cryptographic key between participants for use in a multi-member cryptographic wallet according to the above method.

Also described herein is a system for adaptive key segmentation of a cryptographic key between participants for use in a multi-member cryptographic wallet comprising: a memory; a processor to: determine a derivative key based on the cryptographic key; generate plurality of bitmasks for splitting the derivative key, wherein a bitmask indicates for each bit in the derivative key whether the bit is required by a participant; generate m segments based on using the plurality of bitmasks on the derivative key wherein m is the number of participants; associate each segment with a corresponding participant; and distribute each segment to the corresponding participant, wherein, in use, the cryptographic key can be reconstructed from n segments to sign a transaction and wherein n is a minimum number of participant segments required based on a signature configuration for the multi-member cryptographic wallet.

Further aspects and embodiments will become apparent from the following description, given by way of example and with reference to the accompanying drawings.

### BRIEF DESCRIPTION OF THE DRAWINGS

Examples of the present disclosure will be described with reference to the accompanying figures in which:

FIG. 1 illustrates an example system for adaptive key segmentation of a cryptographic key between participants for use in a multi-member cryptographic wallet.

FIG. 2 illustrates an example general solution table.

FIG. 3 illustrates an example of determining bitmasks from the solution table.

FIG. 4 illustrates an example of generating segments from the bitmasks.

FIG. 5 illustrates an example system with a mediator.

FIG. 6 illustrates an example of adding a new participant.

FIG. 7 illustrates an example of participants providing public keys for encryption.

FIG. 8 illustrates an example method for adaptive key segmentation of a cryptographic key between participants for use in a multi-member cryptographic wallet.

FIG. 9 illustrates an example computer system configurable to implement various features and embodiments described herein adaptive key segmentation of a cryptographic key between participants for use in a multi-member cryptographic wallet.

### DETAILED DESCRIPTION OF THE EMBODIMENTS

Overview

The current disclosure relates to a method and system for adaptive key segmentation of a cryptographic key between participants for use in a multi-member cryptographic wallet.

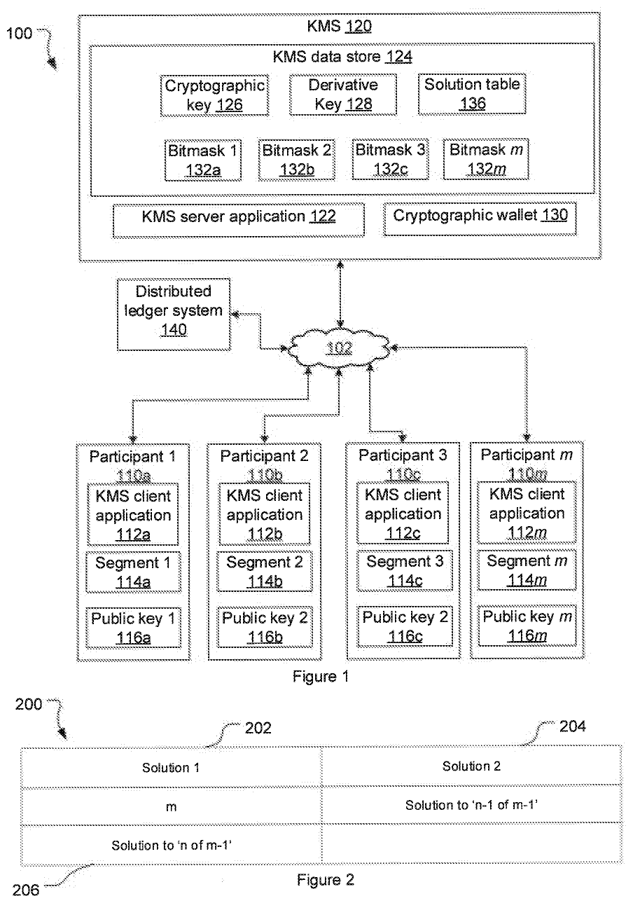

FIG. 1 is an example illustration of a system 100 for adaptive key segmentation of a key 126. In this example, there is a key management system (‘KMS’) 120 which is running a KMS server application 122 and a cryptographic wallet 130, which is typically a software application that interfaces with a distributed ledger system 140. The KMS has a KMS data store 124, which stores the cryptographic key 126, derivative key 128, a solution table 136 and bitmasks 132a to 132m.

The KMS 120 is connected to a distributed ledger system 140 and one or more participants 110a to 110m, where m is the number of participants, via a communication network 102. Each participant 110a to 110m has a KMS client application 112a to 112m, a segment 114a to 114m, and a public key 116a to 116m. The use of public keys to encrypt communications with the corresponding participants is described in more detail below.

At a high level, the system 100 operates by generating a derivative key 128 from the cryptographic key 126. Bitmasks 132a to 132m are generated based on a solution table 136 and these bitmasks are used to split the derivative key into segments 114a to 114m. Each of the segments 114a to 114m are respectively associated with, and subsequently distributed to participants 110a to 110m.

In use the key 126 can be reconstructed by the KMS 120 receiving n (or more) segments from the participants 110 to sign a transaction of the cryptographic wallet 130, wherein n is a minimum number of participant segments required based on a signature configuration for the multi-member cryptographic wallet.

In this example, key 126 is a cryptographic key which can be used to sign transactions to and from a cryptographic wallet 130. In this disclosure reference is made to cryptographic keys but it is to be understood that any key for any cryptographic purpose can be split via the method described in this disclosure. Cryptographic keys can be any type of key that is used in cryptography, including private keys, shared secret keys or one-time keys. It is to be understood that even though the disclosure refers to a single cryptographic key, multiple cryptographic keys can be segmented according to the method described in this disclosure.

In this disclosure reference is made both to cryptographic keys as well as derivative keys. Derivative keys are keys that are derived from a cryptographic key. Cryptographic keys and derivative keys, while typically not the same key, can be interchangeable in some embodiments. For example, as will be explained in more detail below a bitmask can be applied to a cryptographic key in the same way a bitmask can be applied to a derivative key.

In the example of FIG. 1, for additional security a derivative key 128 based on the cryptographic key 126 is generated. The derivative key can be generated by applying a function to the cryptographic key, which therefore hides the real value of the cryptographic key. While generating and using a derivative key can provide security advantages, in certain embodiments the methods described herein could equally be applied to the cryptographic key itself. This may be sufficient for situations where additional security is not necessary, such as in a local area network.

A digital wallet such as the cryptographic wallet 130 is a software program that stores cryptographic and public keys and typically interfaces with a blockchain (or ledger) to enable users to perform transactions, for example to send and receive cryptocurrency. While this disclosure describes key segmentation for use in a multi-member cryptographic wallet, it is to be understood that key segmentation could be used for many types of cryptographic applications and is not limited to wallets.

As there are multiple participants, this can be considered a “multi-member” wallet. As will be explained in further detail below it is worth noting that when a participant “signs” a transaction, they do not necessarily provide their signature as they would in a multi-signature system but rather their segment 114a to 114m of the derivative key 128. In some embodiments, the participants may provide their signature and their segment of the derivative key.

Splitting a Key into Segments

In the example in FIG. 1, KMS 120 generates plurality of bitmasks 132a to 132m and the adaptive key segmentation is based on a bitmasks 132a to 132m. A given bitmask 132 contains values corresponding to each bit in the derivative key 128, each value indicating whether the corresponding bit of the key is distributed to a participant or not.

A bit in this disclosure typically refers to an element in a key, which may be a hexadecimal alphanumeric character but it is to be understood that a bit could apply to binary digits as well. In some embodiments, the KMS 120 may convert hexadecimal to binary bits prior to using the bitmasks. There are multiple bitmasks 132a to 132m illustrated, which are each associated with a participant.

Therefore the bitmasks 132a to 132m are used by the KMS 120 to split the derivative key 128 into segments 114a to 114m. That is, the KMS 120 splits the derivative key 128 into m segments, where m is the number of participants. In the present example, the number of participants is 3, namely 110a, 110b and 110c, so therefore there are 3 segments 114a, 114b and 114c that are generated using the 3 bitmasks 132a, 132b, 132c on the derivative key 128.

Once the derivative key 128 has been split up into segments 114a to 114m, the KMS 120 associates each segment with a participant 1110a to 110m and subsequently distributes each segment to its associated participant (e.g. by communicating it to the relevant participant account/device). In this example, segment 114a is associated with participant 110a, segment 114b is associated with participant 110b, segment 114c is associated with participant 110c, and segment 114m is associated with participant 110m. There can be any number of participants and therefore any number of segments although practically larger size keys would need to be used for a larger number of participants. Cryptographic keys (and therefore derivative keys referred to in this disclosure) are usually 256 bits, or 64 bytes according to the typical cryptographic schemes. Alternative key lengths are, however, possible—and what is currently a normal key length may well change (lengthen) in the future. Larger keys may need to be used for a larger number of participants. For example, a key of 256 bits could not be split between more than 256 participants because each participant would have to receive part of a bit, but a key of 1024 bits could. Smaller key lengths are also possible, however provide less security.

In use, the segments of the cryptographic key 126 are generated in such a way that the key 126 can be reconstructed from at least n segments 114a to 114m. Accordingly, n is a minimum number of participant segments required based on a signature configuration for the multi-member cryptographic wallet 120. For example, where the signature configuration is a ‘2 of 3’ then m, the number of participants, is 3 and therefore there are 3 segments. Further in this example, n, the minimum number of participant segments required is 2. Therefore the cryptographic key would need to be able to be reconstructed from any 2 of the 3 segments.

In this example where a derivative key 128 is used, the cryptographic key can be reconstructed by first reconstructing the derivative key 128 from at least n segments of the segments 114a to 114m. The cryptographic key 102 is then obtained based on the reconstructed derivative key 128—for example by reversing the derivation function or other method by which the derivative key 128 was generated.

Solution Table Based on Signature Requirements

In the present embodiment, in order to determine bitmasks for splitting the derivative key, a solution table 136 is generated by the KMS 120. The solution table represents the potential actions for each participant 110a to 110m. In any given transaction involving the wallet 130, the potential actions for each of those participants are that they may or may not sign the transaction. If there were three participants 110a, 110b, 110c, then there are 8 (2ⁿ, where n=the number of participants) signing combinations for the three participants.

Where the signature configuration of the cryptographic wallet is, for example, ‘2 of 3’ then accessing the wallet/performing a wallet transaction requires a signature from any two of the three participants 110a, 110b, 110c. A signature in this case (and notably how this term is used in this disclosure) is the provision of the segment associated with the participant. This means that out of the total number of signing combinations (in this example the total is 8), only four combinations of signatures will result in a valid signature: (participants 110a and 110b signing); (participants 110a and 110c signing); (participants 110b and 110c signing); and (all participants 110a, 110b, and 110c signing). A solution table can therefore be generated to reflect the four potential solutions.

A solution table can take multiple formats. In this disclosure, typically each row in the solution table represents a combination of signatures where the column represents whether or not each participant provides a signature in that particular solution (a ‘solution’ in this context being a combination of signatures that provides access to the wallet).

In one example solution table with three participants, the first participant 110a can be considered individually and then the solutions for the remaining participants can be found. Participant 110a can either sign or not sign. In the case where participant 110a does not sign, then both participants 110b and 110c would need to sign. In the case where participant 110a does sign, then only one of participants 110b and 110c would need to sign.

This example is illustrated in the following table.

| Problem 1 | Problem 2 |
|---|---|
| 110a signs | 110b or 110c need to sign |
| 110b and 110c both sign | 110a doesn't sign |

The solution to the first problem and the simplified second problem can be represented as follows.

| Solution 1 | Problem 2 |
|---|---|
| 110a | 110b, 110c |

| | |
|---|---|
| 110b | 110c |

This simplifies to

| | |
|---|---|
| 110a | 110b, 110c |

| | |
|---|---|
| 110b | 110c |

The above table illustrates, in a simplified form, that where 110a signs, one of 110b or 110c needs to sign, but where 110a doesn't sign, 110b, 110c both need to sign.

FIG. 2 illustrates a solution table 200 for a general case. This general solution table can be calculated recursively or it can be calculated via combinatorics based on which combinations are valid signatures as outlined above.

In the general solution table 200 the total number of participants is represented as ‘m’ and the number of participants that are required to sign is represented as ‘n’. In the general solution table, the first participant signing is represented as simply ‘n’. The second part of the first solution is the solution to ‘n of m−1.’ That is, because participant ‘n’ does not sign in the second part of the first solution, there must be ‘n’ signatures out of the remaining ‘m−1’ participants.

In this general solution table 200 there is a first solution 202 and a second solution 204. The first solution 202 represents the potential solutions for the first participant, that is, the solutions for whether the first participant signs or does not sign. The second solution 204 represents the potential solutions for the remaining participants where the first participant signs.

The first solution 202 has two parts: the first part is the simple case that the participant signs and the second part is the solution to where the first participant does not sign. In the example of a signature configuration 2 of 3, the first part of the first solution contains a row for participant 110c signing (represented as ‘m’ in the table). The second part 206 of the first solution contains a row for participant 110c not signing. In this case, the solution to participant 110c not signing means the solution must be ‘2 of 2’, which is a situation where the remaining participants must both sign.

The second solution 204 is the solution for the situation where participant 110 signs. In the example of a ‘2 of 3’ solution configuration, then the situation where participant 110c signs means that the second solution is a ‘1 of 2’. That is, participant 110c signs, so therefore only one of participant 110b and 110a would need to sign. The solution table can therefore be calculated for the participant 110b signing and not signing and then finally for the participant 110a signing and not signing.

Generating a Bitmask from the Solution Table

Once a solution table has been calculated for all the participants, the solution table can be used to generate a plurality of bitmasks. A bitmask is a sequence of indicators (in this case binary digits—i.e. ‘1’ and ‘0’s), each indicator/bit denoting whether or not the corresponding bit of the derivative key will appear in a key segment after the bitmask is applied to the derivative key. If a bitmask is all ‘0’s, the resulting segment (once the bitmask is applied to the derivative key) will have none of the derivative key. With a bitmask of all the resulting segment will contain the entire derivative key. With half the bitmask being 1's and the other half 0's, the resulting segment will have half the derivative key.

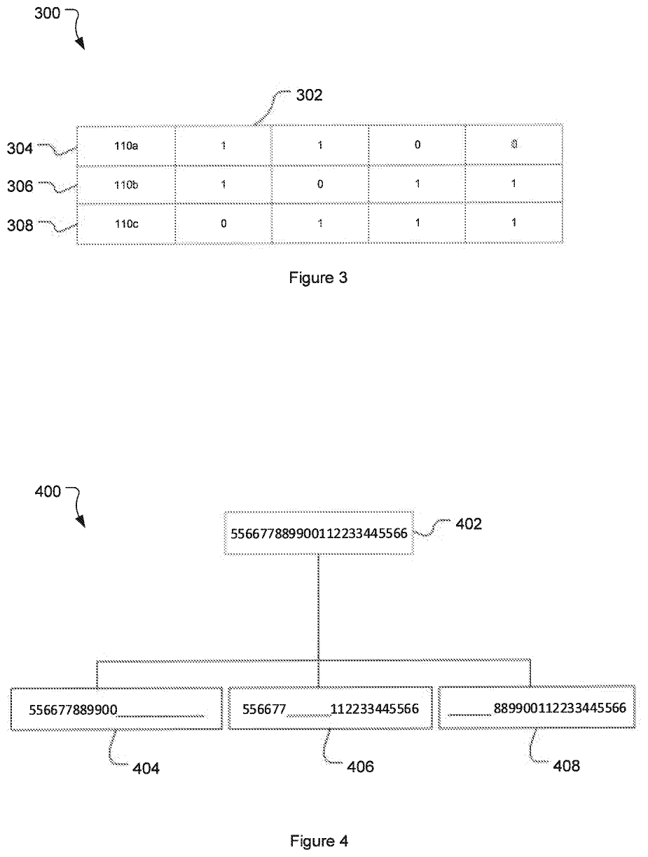

FIG. 3 illustrates an example solution table 300 converted into multiple bitmasks. Each row in the solution table corresponds to a participant 110a,110b,110c, and each column 302 indicates a particular solution. Each cell of the solution table indicates which piece of the key is distributed (the entries that are ‘1’) or not distributed (entries that are ‘0’) to the participant. As this example is a ‘2 of 3’ signature configuration, each of the four solution columns have at least two entries that are ‘1’.

Each bitmask is a binary representation of which participants sign (that is, the solutions described above) in each potential situation in the solution table. Where a participant signs, then the entry for that cell in the solution table becomes a ‘1’ in the bitmask. Similarly, where a participant does not sign, then the entry for that cell is a ‘0’ in the bitmask.

Accordingly in the example in FIG. 3, participant 110a has the bitmask ‘1100’, participant 110b has the bitmask ‘1011’ and participant 110c has the bitmask ‘0111.’

It is alternatively possible to generate the bitmasks linearly by considering the valid combinations of the participants. For example, considering the numbers between 1 and 2^{m} the valid combinations are the binary representations of those numbers that have at least n 1's.

| | Binary representation | At least n 1's |
|---|---|---|
| Number | (using m bits, where m = 3) | (where n = 2) |
| 0 | 000 | No |
| 1 | 001 | No |
| 2 | 010 | No |
| 3 | 011 | Yes |
| 4 | 100 | No |
| 5 | 101 | Yes |
| 6 | 110 | Yes |
| 7 | 111 | Yes |

An alternative method for generating a bitmask would be to consider the binary representations that contain only ‘n’ 1's (as opposed to at least ‘n’ 1's per the above example). This results in smaller bitmasks which may provide efficiency in some cases. The example above remains illustrative of the general concept, but from the perspective of efficiency, where n is 2, the number 7 (or ‘111’ in binary) would be unnecessary for bitmask generation as there are 3 1's and therefore this would mean all participants have the same piece of the key.

Therefore the list of valid combinations becomes the following table:

| | | |
|---|---|---|
| 0 | 1 | 1 |
| 1 | 0 | 1 |
| 1 | 1 | 0 |
| 1 | 1 | 1 |

The solutions for each participant are indicated by each column, which for simplicity is indicated below by rotating the above table.

| | | | |
|---|---|---|---|
| 1 | 1 | 0 | 1 |
| 1 | 0 | 1 | 1 |
| 0 | 1 | 1 | 1 |

Each row can be associated with a participant as illustrated in the table below.

| | | | | |
|---|---|---|---|---|
| Participant 110a | 1 | 1 | 0 | 1 |
| Participant 110b | 1 | 0 | 1 | 1 |
| Participant 110c | 0 | 1 | 1 | 1 |

This becomes the bitmask for each participant: that is, participant 110a is associated with the bitmask ‘1101’, participant 110b is associated with the bitmask ‘1011’, and participant 110c is associated with ‘0111’).

Generating Segments Via a Bitmask

Once the bitmasks have been generated, a derivative key can be split into segments. Each segment has one or more pieces of the key. As will be explained below, a piece of the key is determined based on the bitmasks, so, as an example, a bitmask with four bits, will have four pieces. Given the key has more than four characters (or bits), each piece of the key therefore is multiple characters (or bits) of the key.

FIG. 4 illustrates generating segments by splitting the key. In this example there is a cryptographic key 402 which is ‘556677889900112233445566’. This example is simplified for illustrative purposes and would be much more complex in practice. It is worth noting that normally the derivative key would be the key being split, but in this case (again for simplicity) the derivative key is the cryptographic key 402.

Using the example bitmasks from FIG. 3, there are four bits to each bitmask. Accordingly, the key will be split into four pieces. As the example key is 24 characters in total, each piece of the key is 6 characters (24/4). The first piece is the first 6 characters of the key ‘556677’, the second is the second 6 characters of the key ‘889900’, the third is the third 6 characters of the key ‘112233’, the fourth the first fourth six characters of the key ‘445566’.

More generally, for bitmasks of x bits and keys of y characters, x key pieces are required. Various mechanisms may be used to divide the y key characters into x pieces. By way of example, however, the first x−1 key pieces may be assigned (floor(y/x)) characters of the key (in a sequential manner), and the xth key piece assigned the remaining characters of the key (i.e. y*((x−1)*(floor(y/x))). Bitmasks are generally the same length as the derivative key or a power of the derivative key. In rare cases (9 of 18 wallets for example) where the bitmask is longer than the derivative key, the derivative key is doubled upon itself to fit the bitmask.

According to the bitmask 304, the first segment 404 would include the first piece and the second piece of the key as this corresponds to the bitmask ‘1100’. The second segment 406 would include first, third and fourth pieces of the key as per the bitmask ‘1011’. The third segment 408 would include the second, third and fourth pieces of the key in accordance with the bitmask ‘0111’.

Each of these segments can be associated with a participant, in this example the segment 404 is associated with participant 110a, the segment 406 is associated with the participant 110b and the segment 408 is associated with participant 110c.

In some embodiments, where a key piece is not distributed to the participant, the missing piece or pieces can be filled with random characters. This means that a participant does not gain any information about which parts of the key are the real parts, plus any attacker would not be able to gain similar information. The bitmask can still be used in reverse to extract the relevant pieces of the key when it is needed to reconstruct the key.

Once the segments have been associated with the participants, they can be distributed to the participants. In certain embodiments, participants' public key are obtained and used to encrypt the segments. This provides an additional layer of security in keeping the segments more secure. This will be explained in more detail below.

Mediator

In some embodiments, a mediator performs the splitting of the key and distribution of the segments to the participants (e.g. KMS 120 is maintained/operated by a mediator). The mediator typically would be independent of the participants as this configuration provides additional security. The mediator generally controls the key generation potentially including both generation of the cryptographic key and the derivative key. The mediator would also generally control key reconstruction for use in a digital cryptographic wallet.

It is to be understood that aspects of a mediator could be performed by a third party. For example, the cryptographic key may be generated by a cryptographic wallet application or by a distributed ledger system that the mediator interfaces with. In some situations, the mediator could be part of or performed by one or more of the participants. In such situations, the participants may perform aspects of the mediator including, with appropriate security measures, key generation.

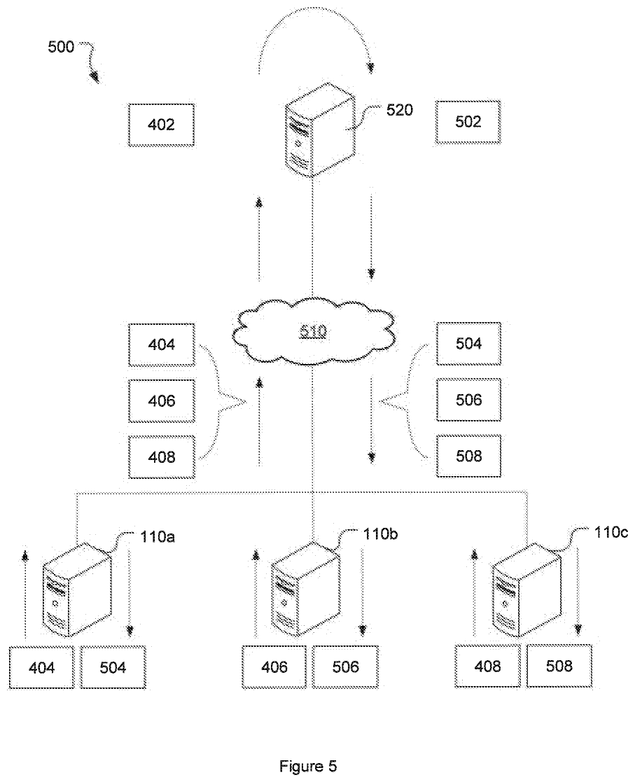

An example of a system with a mediator is illustrated in FIG. 5. In this example, the system 500 with a mediator 502 performs the splitting and distribution of the segments 404, 406, 408 to the participants 110a, 110b, 110c that are connected over a communications network 510. The communications network 510 can be any type of communications network such as the internet or local network.

In the example of FIG. 5, the mediator 520 has access to a cryptographic wallet. The mediator may also access a blockchain system, distributed ledger technology system, or other general cryptographic system in which the cryptographic wallet is transacting.

The mediator 520 can reconstruct the cryptographic key 402 from the segments that have been distributed to the participants. This may be necessary in any situation where the key is required to be used, such as where a key is needed for signing a transaction of the cryptographic wallet.

The mediator 520 can additionally generate a new key 502. In this scenario, the previously split key 402 can be reconstructed by each of the participants 110a, 110b, 110c providing their corresponding segment 404, 406, 408 to the mediator 520. Once all the segments have been received (or alternatively in some embodiments enough segments to reconstruct the key based on the signature configuration), the new key 502 can be generated. The new key 502 would typically be a new derivative key based on the same cryptographic key as 402, that is, the original key does not necessarily need to change. However, it is possible, in some embodiments, to change the cryptographic key.

The new key 502 can be split according to a bitmask much in the same way the previous key 402 was split. This means the new segments 504, 506 and 508 are generated by splitting the cryptographic key 502. These are associated with the participants 110a, 110b, 110c and distributed to the participants accordingly.

It is to be noted that there may be differences in the way in which the split occurs for a new key 502 compared to a previously generated key 402 in order to prevent too much being learnt about the keys or the system as a whole. For example, the order of the columns of the solution table is important to the generation of the derivative key, however the columns may be randomised when generating a new derivative key and the corresponding new segments. As a result, the bitmask (or bitmasks associated with each participant) may change between different derivative keys.

So for example, returning to FIG. 3, the bitmasks that were derived from the table were ‘1100’ associated with participant 110a, ‘1011’ associated with participant 110b, and ‘0111’ associated with participant 110c. For the new key 502, the bitmasks could be ‘0101’, ‘1110’ and ‘1011’. Notably, this does not affect the signature configuration as the new key 502 will still be able to be reconstructed from the new segments. This property of the bitmasks is apparently by noting that each column still has at least two ‘1’s.

Changing the Number of Participants

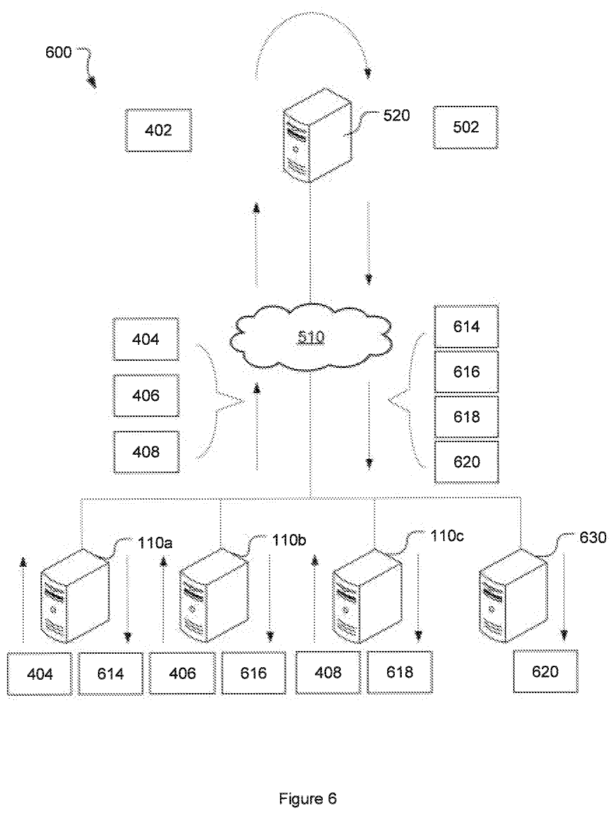

The new key 502 does not necessarily have to be split according to the same number of participants as the previous key 402. FIG. 6 illustrates an example where there is a new participant 630 that has been added.

In this example, the participants 110a, 110b, 110c have been previously allocated and distributed segments 404, 406, 408. The mediator 520 receives the segments from the participants 110a, 110b, 110c. The mediator can then reconstruct the key 402 and generate a new key 502.

Once the new key 502 has been generated, the mediator 520 can split the key into the new segments. In this case, there are four participants 110a, 110b, 110c, 630. Common signature configurations for four participants would be ‘1 of 4’, ‘2 of 4’, ‘3 of 4’ and ‘4 of 4’, each of which have different security implications. In this example the new signature configuration determined by the mediator is a ‘3 of 4’ configuration, that is a key segment from three participants out of the four participants would be required to sign a transaction.

As above, potential actions for each of those participants in a given transaction are that they may or may not sign the transaction. Therefore there are 16 (2ⁿ, where n=4) potential results for the four participants. However, only 5 out of the 16 potential results will be able to sign a transaction in a ‘3 of 4’ signature configuration. That is, the combinations of signatures would validly sign a transaction (participants 110a, 110b, 110c), (participants 110a, 110b, 630), (participants 110a, 110c, 630), (participants 110b, 110c, 630), (participants 110a, 110b, 110c, 630). The other combinations of signatures, that is those combinations that provide 2 or less signatures from the participants would be insufficient to sign a transaction. Therefore in the example of FIG. 6, the solution table and bitmasks would need to be calculated to reflect the new signature configuration.

Based on the new bitmasks, the new key 502 can be split into the segments 614, 616, 618 and 620. Each segment is then associated with a participant and distributed accordingly to the new participant, that is, the participants 110a, 110b, 110c plus the new participant 630. Although not illustrated, it should be apparent that removing one or more participants or adding multiple participants would operate in a similar way.

It is notable that in some embodiments, the segments 404, 406, 408 do not need to be received by the mediator 520. Receiving the segments may only be necessary where the wallet is maintaining the key and requires the previous key 402 in order to change it to a new key 502. This would mean the mediator does not store or otherwise maintain the key which is preferable from a security perspective. Therefore in most scenarios, the mediator cannot generate a new key 502 without knowing the previous key 402 first. However, this is not required in all situations as, for example, the mediator may store the key 402. In such cases, the mediator may simply be notified that a new participant is to be added, generate the new key and new segments and then distribute them to the new participants. The old segments 404, 406 408 would be made redundant in this scenario and therefore could be discarded by the participants.

Providing Public Keys for Additional Security

The new key 502 can be encrypted or obfuscated to hide the contents of the key, so that it is difficult for a nefarious actor (such as an attacker or hacker) to learn the full key from simply listening to communications between the participants 110a, 110b, 110c and the mediator 520.

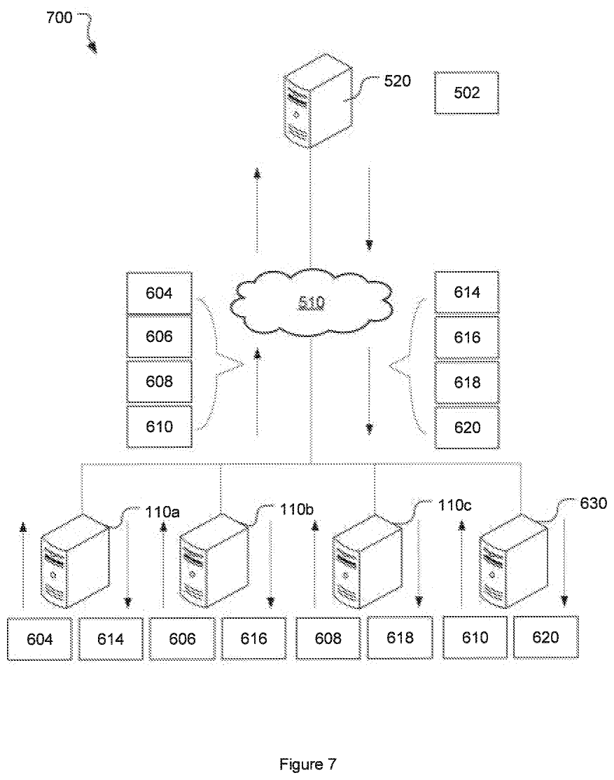

In some embodiments, the participants have their own public key which can be used to encrypt communications with them (or, at least, their key segments) so that important data can be hidden. FIG. 7 illustrates an example where the mediator is generating a derivative key 502 and each of the participants 110a, 110b, 110c, 630 provide the mediator 520 with their public key. The key segments 614, 616, 618, 620 can then be encrypted with the public key corresponding to each participant.

In FIG. 7, each participant 110a, 110b, 110c, 630 has a corresponding public key 604, 606, 608, 610. Each of those participants sends their public key to the mediator 520. In this example, the participants 110a, 110b, 110c, 630 are all new participants so none of them would have a segment yet.

In FIG. 7 the mediator receives public keys 604, 606, 608, 610 from the participants. The mediator 520 then generates a key 502, determines the new segments 614, 616, 618, 620 which are then associated with each participant, that is, associating each segment with one of the participants 110a, 110b, 110c, 630. Prior to distributing the segments to the participants, the mediator 502 encrypts each segment with the corresponding public key (604, 606, 608, 610) of the participant. This means that the segments are protected with an extra layer of security, that is, the public key encryption. This may be particularly important where the communications network 510 is the internet where anyone can see the data packets unless the communications are encrypted.

Example Method

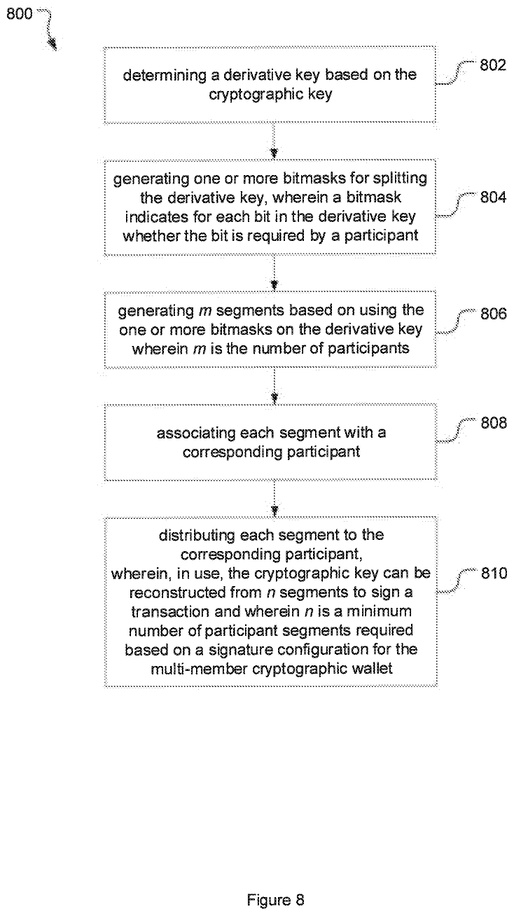

An example method of adaptive key segmentation of a cryptographic key between participants for use in a multi-member cryptographic wallet is illustrated in FIG. 8. In this method 800, the first step is to determine 802 a derivative key based on the cryptographic key. The derivative key could be the result of a function applied to the cryptographic key in order to generate the derivative key. The derivative key may even be the cryptographic key itself, which may be sufficient for situations where additional security is not necessary, such as in a local area network.

The next step is to generate 804 bitmasks for splitting the derivative key, wherein a bitmask indicates for each bit in the derivative key whether the bit is required by a participant.

Once the bitmasks are generated, the bitmasks can be used for generating 806 m segments wherein m is the number of participants. This is based on applying the bitmasks to the derivative key.

Each of the segments generated at step 806 is associated 808 with a corresponding participant.

The final step is to distribute 810 each segment to the corresponding participant. In use the cryptographic key (or derivative key) can be reconstructed from n shards to sign a transaction and wherein n is a minimum number of participant shards required based on a signature configuration for the multi-signature cryptographic wallet.

Example System

The present invention is necessarily implemented using one or more computer processing systems. For example, each participant in the foregoing description makes use of a computer processing system (e.g. in order to receive key segments and use those key segments to authorize wallet transactions). Similarly, the mediator system is a computer processing system that performs various processing operations (e.g. bitmask generation, key segmentation, key reassembly, encryption/decryption), communicates with the participant computer processing systems (e.g. to send/receive key segments), and interacts with the digital wallet (e.g. to perform transactions).

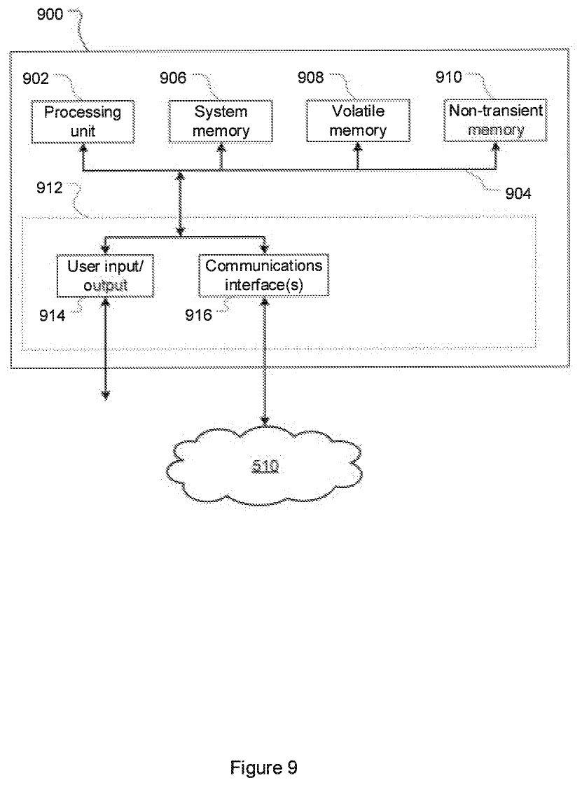

FIG. 9 provides a block diagram of one example of a computer processing system 900. System 900 as illustrated in FIG. 9 is a general-purpose computer processing system. It will be appreciated that FIG. 9 does not illustrate all functional or physical components of a computer processing system. For example, no power supply or power supply interface has been depicted, however system 900 will either carry a power supply or be configured for connection to a power supply (or both). It will also be appreciated that the particular type of computer processing system will determine the appropriate hardware and architecture, and alternative computer processing systems suitable for implementing aspects of the invention may have additional, alternative, or fewer components than those depicted, combine two or more components, and/or have a different configuration or arrangement of components.

The computer processing system 900 includes at least one processing unit 902. The processing unit 902 may be a single computer-processing device (e.g. a central processing unit, graphics processing unit, or other computational device), or may include a plurality of computer processing devices. In some instances all processing will be performed by processing unit 902, however in other instances processing may also, or alternatively, be performed by remote processing devices accessible and useable (either in a shared or dedicated manner) by the system 900.

Through a communications bus 904 the processing unit 902 is in data communication with a one or more machine-readable storage (memory) devices that store instructions and/or data for controlling operation of the processing system 900. In this instance system 900 includes a system memory 906 (e.g. a BIOS), volatile memory 908 (e.g. random access memory such as one or more DRAM modules), and non-volatile memory 910 (e.g. one or more hard disk or solid state drives).

System 900 also includes one or more interfaces, indicated generally by 912, via which system 100 interfaces with various devices and/or networks. Generally speaking, other devices may be physically integrated with system 900, or may be physically separate. Where a device is physically separate from system 900, connection between the device and system 900 may be via wired or wireless hardware and communication protocols, and may be a direct or an indirect (e.g. networked) connection.

Wired connection with other devices/networks may be by any appropriate standard or proprietary hardware and connectivity protocols. For example, system 900 may be configured for wired connection with other devices/communications networks by one or more of: USB; FireWire; eSATA; Thunderbolt; Ethernet; OS/2; Parallel; Serial; HDMI; DVI; VGA; SCSI; AudioPort. Other wired connections are, of course, possible.

Wireless connection with other devices/networks may similarly be by any appropriate standard or proprietary hardware and communications protocols. For example, system 900 may be configured for wireless connection with other devices/communications networks using one or more of: infrared; Bluetooth; Wi-Fi; near field communications (NFC); Global System for Mobile Communications (GSM), Enhanced Data GSM Environment (EDGE), long term evolution (LTE), wideband code division multiple access (W-CDMA), code division multiple access (CDMA). Other wireless connections are, of course, possible.

Generally speaking, the devices to which system 900 connects—whether by wired or wireless means—allow data to be input into/received by system 900 for processing by the processing unit 902, and data to be output by system 900. Example devices are described below, however it will be appreciated that not all computer-processing systems will include all mentioned devices, and that additional and alternative devices to those mentioned may well be used.

For example, system 900 may include or connect to one or more input devices by which information/data is input into (received by) system 900. Such input devices may include physical buttons, alphanumeric input devices (e.g. keyboards), pointing devices (e.g. mice, track pads and the like), touchscreens, touchscreen displays, microphones, accelerometers, proximity sensors, GPS devices and the like. System 100 may also include or connect to one or more output devices controlled by system 900 to output information. Such output devices may include devices such as indicators (e.g. LED, LCD or other lights), displays (e.g. CRT displays, LCD displays, LED displays, plasma displays, touch screen displays), audio output devices such as speakers, vibration modules, and other output devices. System 100 may also include or connect to devices which may act as both input and output devices, for example memory devices (hard drives, solid state drives, disk drives, compact flash cards, SD cards and the like) which system 100 can read data from and/or write data to, and touch-screen displays which can both display (output) data and receive touch signals (input).

System 900 may also connect to communications networks (e.g. the Internet, a local area network, a wide area network, a personal hotspot etc.) to communicate data to and receive data from networked devices, which may themselves be other computer processing systems.

It will be appreciated that system 900 may be any suitable computer processing system such as, by way of non-limiting example, a desktop computer, a laptop computer, a netbook computer, tablet computer, a smart phone, a Personal Digital Assistant (PDA), a cellular telephone, a web appliance. Typically, system 900 will include at least user input and output devices 914 and (if the system is to be networked) a communications interface 916 for communication with a network 510. The number and specific types of devices which system 900 includes or connects to will depend on the particular type of system 900. For example, if system 900 is a desktop computer it will typically connect to physically separate devices such as (at least) a keyboard, a pointing device (e.g. mouse), a display device (e.g. a LCD display). Alternatively, if system 900 is a laptop computer it will typically include (in a physically integrated manner) a keyboard, pointing device, a display device, and an audio output device. Further alternatively, if system 900 is a tablet device or smartphone, it will typically include (in a physically integrated manner) a touchscreen display (providing both input means and display output means), an audio output device, and one or more physical buttons.

System 900 stores or has access to instructions and data which, when processed by the processing unit 902, configure system 900 to receive, process, and output data. Such instructions and data will typically include an operating system such as Microsoft Windows®, Apple OSX, Apple 105, Android, Unix, or Linux.

System 900 also stores or has access to instructions and data (i.e. software) which, when processed by the processing unit 902, configure system 900 to perform various computer-implemented processes/methods in accordance with embodiments of the invention (as described below). It will be appreciated that in some cases part or all of a given computer-implemented method will be performed by system 900 itself, while in other cases processing may be performed by other devices in data communication with system 900.

Instructions and data are stored on a non-transient machine-readable medium accessible to system 900. For example, instructions and data may be stored on non-transient memory 110. Instructions may be transmitted to/received by system 900 via a data signal in a transmission channel enabled (for example) by a wired or wireless network connection.

As used herein, except where the context requires otherwise, the term “comprise” and variations of the term, such as “comprising”, “comprises” and “comprised”, are not intended to exclude further additives, components, integers or steps.

It will be understood that the embodiments disclosed and defined in this specification extend to alternative combinations of two or more of the individual features mentioned in or evident from the text or drawings. All of these different combinations constitute alternative embodiments of the present disclosure.

The present specification describes various embodiments with reference to numerous specific details that may vary from implementation to implementation. No limitation, element, property, feature, advantage or attribute that is not expressly recited in a claim should be considered as a required or essential feature. Accordingly, the specification and drawings are to be regarded in an illustrative rather than a restrictive sense.

1. A computer implemented method for adaptive key segmentation of a cryptographic key between participants for use in a multi-member cryptographic wallet, the method comprising:
determining, by a processing unit, a derivative key based on the cryptographic key;
generating a plurality of bitmasks for splitting the derivative key, wherein a bitmask indicates for each bit in the derivative key whether the bit is required by a participant;
generating m segments based on using the plurality of bitmasks on the derivative key wherein m is the number of participants;
associating each segment with a corresponding participant; and
distributing each segment to the corresponding participant, wherein, in use, the cryptographic key can be reconstructed from n segments to sign a transaction and wherein n is a minimum number of participant segments required based on a signature configuration for the multi-member cryptographic wallet.

2. The computer implemented method according to claim 1, wherein generating the plurality of bitmasks comprises determining a solution table for the cryptographic key based on the signature configuration for the multi-member cryptographic wallet.

3. The computer implemented method according to claim 2, further comprising converting the solution table into the plurality of bitmasks.

4. The computer implemented method according to claim 1, wherein the derivative key is the cryptographic key.

5. The computer implemented method according to claim 2, wherein determining a solution table comprises:
determining a first solution for one participant's segment based on signature requirements of the signature configuration; and
determining a second solution for the remaining (n−1) participants' segment based on the remaining signature requirements of the signature configuration.

6. The computer implemented method according to claim 5, wherein determining the second solution comprises recursively applying the steps of the method in claim 5.

7. The computer implemented method according to claim 1, wherein the number of participants is variable.

8. The computer implemented method according to claim 7, further comprising:
receiving n segments from the participants;
reconstructing the cryptographic key from the received segments;
determining a new derivative key based on the reconstructed cryptographic key;
generating one or more new bitmasks for splitting the new derivative key, wherein a bitmask indicates for each bit in the new derivative key whether the bit is required by a participant;
generating x new segments based on using the one or more new bitmasks on the new derivative key, wherein x is a new number of participants;
associating each new segment with a corresponding participant; and
distributing each new segment to the corresponding participant,
wherein, in use, the cryptographic key can be reconstructed from y new segments to sign a transaction and wherein y is a minimum number of participant new segments required based on a signature configuration for the multi-member cryptographic wallet.

9. The method according to claim 1, further comprising:
receiving a public key from each corresponding participant; and
prior to distribution, signing each segment with the corresponding public key for each corresponding participant.

10. The method according to claim 1, wherein the method is performed by a mediator system.

11. The method according to claim 10 further comprising reconstructing, by the mediator system, the cryptographic key from the segments.

12. The method according to claim 11, wherein reconstructing the cryptographic key comprises n participants sending their associated segment to the mediator system.

13. A non-transient computer readable medium having computer readable instructions executable by a processing unit to perform a method for adaptive key segmentation of a cryptographic key between participants for use in a multi-member cryptographic wallet, the method comprising:
determining a derivative key based on the cryptographic key;
generating a plurality of bitmasks for splitting the derivative key, wherein a bitmask indicates for each bit in the derivative key whether the bit is required by a participant;
generating m segments based on using the plurality of bitmasks on the derivative key wherein m is the number of participants;
associating each segment with a corresponding participant; and
distributing each segment to the corresponding participant, wherein, in use, the cryptographic key can be reconstructed from n segments to sign a transaction and wherein n is a minimum number of participant segments required based on a signature configuration for the multi-member cryptographic wallet.

14. A system for adaptive key segmentation of a cryptographic key between participants for use in a multi-member cryptographic wallet comprising:
a memory; and
a processing unit to:
determine a derivative key based on the cryptographic key;
generate plurality of bitmasks for splitting the derivative key, wherein a bitmask indicates for each bit in the derivative key whether the bit is required by a participant;
generate m segments based on using the plurality of bitmasks on the derivative key wherein m is the number of participants;
associate each segment with a corresponding participant; and
distribute each segment to the corresponding participant,
wherein, in use, the cryptographic key can be reconstructed from n segments to sign a transaction and wherein n is a minimum number of participant segments required based on a signature configuration for the multi-member cryptographic wallet.

15. The system according to claim 14, wherein generating the plurality of bitmasks comprises determining a solution table for the cryptographic key based on the signature configuration for the multi-member cryptographic wallet.

16. The computer system according to claim 15, further comprising converting the solution table into the plurality of bitmasks.

17. The computer system according to claim 15, wherein determining a solution table comprises:
determining a first solution for one participant's segment based on signature requirements of the signature configuration; and
determining a second solution for the remaining (n−1) participants' segment based on the remaining signature requirements of the signature configuration.

18. The computer system according to claim 14, wherein the number of participants is variable.

19. A computer implemented method according to claim 18 further comprising:
receiving n segments from the participants;
reconstructing the cryptographic key from the received segments;
determining a new derivative key based on the reconstructed cryptographic key;
generating one or more new bitmasks for splitting the new derivative key, wherein a bitmask indicates for each bit in the new derivative key whether the bit is required by a participant;
generating x new segments based on using the one or more new bitmasks on the new derivative key, wherein x is a new number of participants;
associating each new segment with a corresponding participant; and
distributing each new segment to the corresponding participant, wherein, in use, the cryptographic key can be reconstructed from y new segments to sign a transaction and wherein y is a minimum number of participant new segments required based on a signature configuration for the multi-member cryptographic wallet.

20. A system according to claim 14, further comprising:
receiving a public key from each corresponding participant; and
prior to distribution, signing each segment with the corresponding public key for each corresponding participant.
